(19) United States
(12) Patent Application Publication
(10) Pub. No.: US 2018/0057378 A1
(43) Pub. Date: Mar. 1, 2018

(54) INTERMITTENT CYCLED FILTER APPARATUS AND SYSTEM

(71) Applicant: David Veilleux, Milford, CT (US)

(72) Inventor: David Veilleux, Milford, CT (US)

(21) Appl. No.: 15/247,389

(22) Filed: Aug. 25, 2016

(51) Int. Cl. C02F 3/00; C02F 3/04; B01D 29/01; F04F 10/00

(52) U.S. Cl. CPC C02F 3/006; C02F 3/04; B01D 29/01; C02F 2203/006; C02F 2003/001; C02F 2209/42; F04F 10/00

(57) ABSTRACT

The present invention is an intermittent cycled biological filter. Liquid enters a filtration container through an inlet line and travels to the bottom of an internal cavity of the container, passing through any filtration media in the container. The liquid then exits through a siphon mechanism having external and internal siphon tubes connected to an internal cavity of the container. The liquid travels up external siphon tube, down internal siphon tube, and through an outlet line. A siphon break tube connected to the external siphon tube destroys the suction pulling the liquid up once the liquid level in the container drops below a certain level, allowing liquid to begin filling the container again. This allows intermittent wetting of the filtration media. In certain embodiments, multiple filtration containers may be connected in series and/or parallel to allow for a greater volume or level of filtration.

### STATEMENT REGARDING FEDERALLY SPONSORED RESEARCH OR DEVELOPMENT

The invention described herein was made with support from the National Oceanic and Atmospheric Administration (NOAA) of the United States Department of Commerce. The United States Government has certain rights in the invention.

### FIELD OF INVENTION

This invention relates to the field of liquid purification or separation and more specifically to a particulate material type separator.

### BACKGROUND OF THE INVENTION

Aerobic water treatment systems utilize oxygen and microbes to degrade organic matter and neutralize contaminants such as ammonia, allowing reuse of the water. Typically, aerobic treatment is a two-step process. The first phase is physical filtration of larger particles. Microbes then degrade the remaining organic matter until it is stable and/or less hazardous.

Fixed-media biological filtration methods rely on either trickling water over media or submerging the media in water. Trickling methods involve continual or intermittent trickling of water over large filtration media. Submersion methods rely on continuous operation of a fully submerged filter or other media, which is periodically removed for cleaning or replacement to retain its absorptive capacity.

Several problems are known in the art with respect to both trickling and submersion methods. These methods are susceptible to clogs and blockages, use mechanical valves that may fail after extended use, and cannot simulate tidal action. Both methods require substantial energy to aerate the water to provide oxygen needed for complete biological and chemical processing. Without the aerator, these processes can deoxygenate the water. Water flow in trickle filters may also follow established paths and fail to wet all filtration media.

There is an unmet need in the art for a biofilter capable of self-regulated cleaning and aeration.

### BRIEF SUMMARY OF THE INVENTION

The present invention is an intermittent cycled biological filter. Liquid enters a filtration container through an inlet line and travels to the bottom of an internal cavity of the container, passing through any filtration media in the container. The liquid then exits through a siphon mechanism having external and internal siphon tubes connected to an internal cavity of the container. The liquid travels up external siphon tube, down internal siphon tube, and through an outlet line. A siphon break tube connected to the external siphon tube destroys the suction pulling the liquid up once the liquid level in the container drops below a certain level, allowing liquid to begin filling the container again. This allows intermittent wetting of the filtration media. In certain embodiments, multiple filtration containers may be connected in series and/or parallel to allow for a greater volume or level of filtration.

### BRIEF DESCRIPTION OF SEVERAL VIEWS OF THE DRAWING(S)

FIG. 1 illustrates a cross-sectional view of an exemplary embodiment of an intermittent cycled filter apparatus.

FIGS. 2a and 2b illustrate overviews of exemplary embodiments of intermittent cycled filter systems.

### TERMS OF ART

As used herein, the term “air-lift system” refers to a liquid pump which injects compressed air at the bottom of a discharge pipe which is immersed in the liquid.

As used herein, the term “filtration container” refers to a container holding a filtration medium.

As used herein, the term “filtration medium” refers to a medium capable of removing impurities from a fluid.

As used herein, the term “hose” refers to a substantially flexible tube.

As used herein, the term “inlet line” refers to a fluid line bringing a fluid to a location.

As used herein, the term “internal cavity” refers to a space within a container.

As used herein, the term “internal siphon tube” refers to a tube located within a siphon mechanism.

As used herein, the term “inverted truncated conical” refers to a three-dimensional conical shape tapering downwards and ending in a flat plane.

As used herein, the term “magnetic drive pump” refers to pump using a fluid impeller rotated by a balanced magnetic field.

As used herein, the term “mechanical pump” refers to a device that moves fluids by mechanical action.

As used herein, the term “outlet” refers to a passage through which liquid is dispensed.

As used herein, the term “pipe” refers to a substantially rigid tube.

As used herein, the term “screen” refers to a perforated material capable of passing liquid and block solid particles having a size greater than the screen's perforations.

As used herein, the term “siphon mechanism” refers to a mechanism capable of siphoning a liquid.

As used herein, the term “spray bar” refers to an elongated element having multiple spaced outlets.

As used herein, the term “telescoping” refers to an element capable of slidably expanding or contracting.

### DETAILED DESCRIPTION OF THE INVENTION

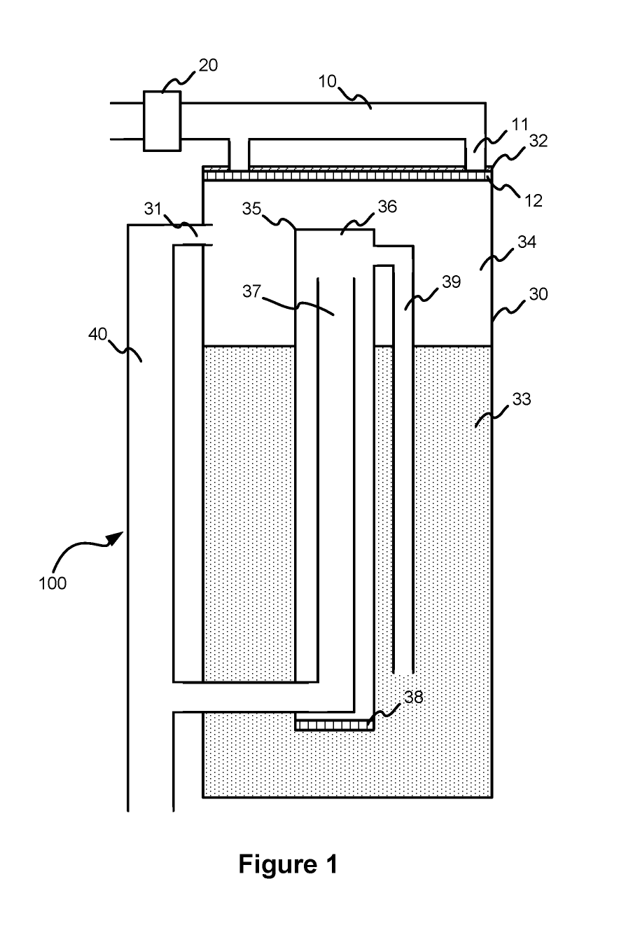

FIG. 1 illustrates a cross-sectional view of an exemplary embodiment of intermittent cycled filter apparatus 100. Waste liquid enters apparatus 100 through an inlet line 10. In certain embodiments, a pump 20, such as a mechanical pump, magnetic drive pump, or an air-lift system, creates waste liquid flow. In other embodiments, gravity causes waste liquid flow through inlet line 10. Inlet line 10 discharges waste liquid into a filtration container 30. After filtering through a filtration medium 33 in an internal cavity 34, filtered liquid is drawn up into siphon mechanism 35 and discharges through an outlet line 40. Siphon mechanism 35 draws filtered liquid from filtration container 30 intermittently, not continuously, allowing cyclic wetting and drying of filtration medium 33.

Inlet line 10 delivers waste liquid to filtration container 30. In the exemplary embodiment, inlet line 10 is a hose or pipe with at least one outlet 11. In other embodiments, inlet line 10 may be a spray bar. In certain embodiments, a particle screen 12 is located between inlet line 10 and filtration container 30 to prevent large particles from fouling filtration medium 33.

Inlet line 10 discharges liquid into an open internal cavity in filtration container 30, above filtration medium 33. This provides a measure of aeration to the waste liquid. In the exemplary embodiment, filtration container 30 is a cylindrical container. In other embodiments, filtration container 30 has an inverted conical base or is shaped like an inverted truncated cone to ensure more efficient liquid flow. Filtration container 30 may have a capacity ranging from one gallon to 100,000 gallons.

In certain embodiments, an overflow tube 31 prevents overfilling of filtration container 30. Overflow tube 31 connects the internal cavity of filtration container 30 to outlet line 40. If the liquid level in filtration container 30 extends above the level of overflow tube 31, then liquid is diverted to outlet line 40. In certain embodiments, a container lid 32, through which outlet 11 extends, at least partially closes filtration container 30 to prevent loss of waste liquid and filtration medium 33. Filtration medium 33 is a particulate medium supporting a biological culture. The particulate medium is a material with a high surface to volume ratio capable of supporting organisms for the biological culture. Such particulate medium can be, but is not limited to, activated charcoal, ceramic beads or balls, lava rock, live rock, ring-covered cord, gravel, wheel-shaped polymer, sintered glass tubes or beads, polymer disks or balls, or mesh mat. The biological culture may be any aerobic biological organism capable of breaking down waste filtered from liquid, and can include microorganisms such as bacteria, algae, fungi, and yeast, and/or macro-organisms such as rotifers, algae, plants, and protozoa. Different wastes may utilize different biological cultures or combinations of biological cultures.

Siphon mechanism 35 includes an external siphon tube 36 and an internal siphon tube 37 located within external siphon tube 36. In the exemplary embodiment, internal siphon tube 37 is located concentrically within external siphon tube 36, but other embodiments may have an off-center or partially merged configuration. The diameters of external siphon tube 36 and internal siphon tube 37 are proportioned such that the internal area of internal siphon tube 37 is approximately equal to the internal area between external siphon tube 36 and internal siphon tube 37. While the upper end of internal siphon tube 37 does not extend beyond the upper end of external siphon tube 36, the lower end of internal siphon tube 37 may extend beyond the lower end of external siphon tube 36 or even a lower end of filtration container 30. The upper end of external siphon tube 36 is closed, and the lower end of external siphon tube 36 is open to allow upward liquid flow from filtration container 30. In certain embodiments, an optional vacuum screen 38 covers the lower end of external siphon tube 36 to prevent particles such as filtration medium 33 from leaving filtration container 30.

The upper end of internal siphon tube 37 is open to allow downward liquid flow from the upper end of external siphon tube 36. The lower end of internal siphon tube 37 is connected to outlet line 40. A siphon break tube 39 extends alongside external siphon tube 36. An upper end of siphon break tube 39 is connected to the interior of external siphon tube 36, between the upper ends of external siphon tube 36 and internal siphon tube 37. A lower end of siphon break tube 39 is located at some point below between the upper end of internal siphon tube 37. The location of the lower end of siphon break tube 39 can be adjusted by removing and replacing siphon break tube 39 with a longer or shorter siphon break tube 39, or by cutting off part of siphon break tube 39. In certain embodiments, siphon break tube 39 telescopes, allowing for positive and negative length adjustment.

In use, waste liquid flows through inlet line 10, and is discharged by outlet 11 into filtration container 30. The waste liquid flows down over filtration medium 33 and fills filtration container 30. As liquid fills filtration container 30, it also fills the area in siphon mechanism 35 between external siphon tube 36 and internal siphon tube 37, rising until it fills external siphon tube 36 and spills over the upper end of internal siphon tube 37. The liquid then runs down internal siphon tube 37 until exiting through outlet line 40. Thereafter, liquid flows out of filtration container 30 until the liquid level in filtration container 30 reaches the lower level of siphon break tube 39. This breaks the siphon, stopping liquid flow and causing any remaining liquid in external siphon tube 36 to descend back into filtration container 30. Liquid will begin to fill filtration container 30 and start the cycle again. The highest and lowest liquid levels are determined by the location of the upper level of internal siphon tube 37 and the location of the lower level of siphon break tube 39, respectively. In order to allow flow, overflow tube 31 must connect to filtration container 30 at a level above the upper level of internal siphon tube 37. Furthermore, the lower end of siphon break tube 39 must be located at or above the lower end of external siphon tube 36.

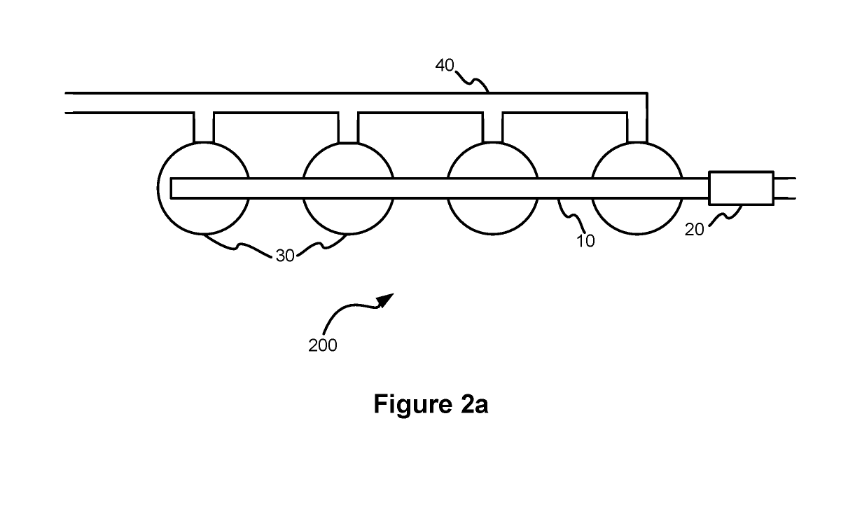

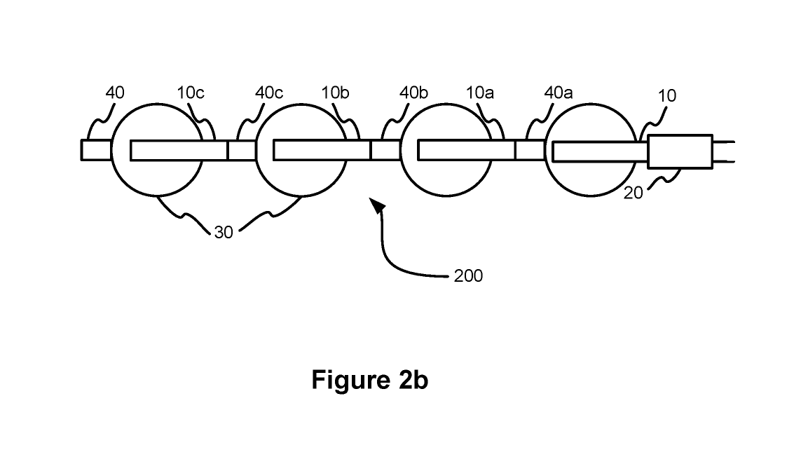

FIGS. 2a and 2b illustrate overviews of exemplary embodiments of intermittent cycled filter systems 200. System 200 is used for high-capacity filtration or to achieve high levels of filtration, such as for highly contaminated liquid or liquid containing multiple contaminants unresponsive to a single filtration medium. Depending on the liquid flow required, each system 100 may include one or more pumps 20. In FIG. 2a, system 200 includes multiple filtration containers 30 connected in parallel between inlet line 10 and outlet line 40. In FIG. 2b, system 200 includes multiple filtration containers 30 connected in series between a first inlet line 10 and a last outlet line 40. In this embodiment, the first outlet line 40a connects to the second inlet line 10a and so on. Certain embodiments may combine both parallel and series filtration.

It will be understood that many additional changes in the details, materials, procedures and arrangement of parts, which have been herein described and illustrated to explain the nature of the invention, may be made by those skilled in the art within the principle and scope of the invention as expressed in the appended claims. Moreover, the terms “substantially” or “approximately” as used herein may be applied to modify any quantitative representation that could permissibly vary without resulting in a change in the basic function to which it is related.

It should be further understood that the drawings are not necessarily to scale; instead, emphasis has been placed upon illustrating the principles of the invention.

What is claimed is:

1. An intermittent cycled filter apparatus comprised of:
an inlet line extending to a filtration container having an internal cavity;
a siphon mechanism connected to said internal cavity, said siphon mechanism comprised of:
an internal siphon tube located within an external siphon tube, an upper end said internal siphon tube terminating before an upper end of said external siphon tube,
a siphon break tube extending from said upper end of said external siphon tube to a point in said internal cavity at or above a lower end of said external siphon tube; and
an outlet line extending from a lower end of said internal siphon tube.

2. The apparatus of claim 1, wherein said inlet line is selected from the group consisting of: a hose with at least one outlet, a pipe with at least one outlet, or a spray bar.

3. The apparatus of claim 2, further including a container lid located between said at least one outlet and said filtration container.

4. The apparatus of claim 1, further including a particle screen located between said inlet line and said filtration container.

5. The apparatus of claim 1, further including at least one pump connected to said inlet line to allow pumping of fluid.

6. The apparatus of claim 5, wherein said at least one pump is selected from the group consisting of: a mechanical pump, magnetic drive pump, and an air-lift system.

7. The apparatus of claim 1, wherein said filtration container has a cylindrical configuration.

8. The apparatus of claim 7, wherein said filtration container has an inverted truncated conical base.

9. The apparatus of claim 1, wherein said filtration container has an inverted truncated conical configuration.

10. The apparatus of claim 1, wherein said filtration container has an overflow tube connecting said internal cavity to said outlet line at a point above said upper end of said internal siphon tube.

11. The apparatus of claim 1, wherein said filtration container contains a particulate filtration medium.

12. The apparatus of claim 11, wherein said particulate medium includes a biological culture.

13. The apparatus of claim 11, wherein said particulate medium is selected from the group consisting of: activated charcoal, ceramic beads or balls, lava rock, live rock, ring-covered cord, gravel, wheel-shaped polymer, sintered glass tubes or beads, polymer disks or balls, and mesh mat.

14. The apparatus of claim 1, wherein said external siphon tube includes a vacuum screen extending across said lower end of said external siphon tube.

15. The apparatus of claim 1, wherein said siphon break tube is a telescoping tube.

16. The apparatus of claim 1, wherein said siphon break tube is a removable tube.

17. An intermittent cycled filter system comprised of:
at least one inlet line extending to at least one of a plurality of filtration containers;
each of said plurality of filtration containers having an internal cavity and a siphon mechanism connected to said internal cavity, said siphon mechanism comprised of:
an internal siphon tube located within an external siphon tube, an upper end said internal siphon tube terminating before an upper end of said external siphon tube,
a siphon break tube extending from said upper end of said external siphon tube to a point in said internal cavity at or above a lower end of said external siphon tube; and
at least one outlet line extending from a lower end of at least one internal siphon tube.

18. The system of claim 17, wherein said plurality of filtration containers are connected in series.

19. The system of claim 17, wherein said plurality of filtration containers are connected in parallel.

20. The system of claim 17, wherein said plurality of filtration containers are connected in series and in parallel.
